(19) United States
(12) Patent Application Publication
(10) Pub. No.: US 2025/0249765 A1
(43) Pub. Date: Aug. 7, 2025

(54) Bimettalic Connector for Charging Cables, for High Voltage Applications

(71) Applicant: Auto-Kabel Management GmbH, Hausen i.W. (DE)

(72) Inventor: Martin Schloms, Aachen (DE)

(21) Appl. No.: 18/856,289

(22) PCT Filed: Mar. 30, 2023
(86) PCT No.: PCT/EP2023/058225

§ 371 Date: Oct. 11, 2024

(30) Foreign Application Priority Data
Apr. 20, 2022 (DE) 10 2022 109 502.9

(51) Int. Cl. B60L 53/16; B60L 53/302; H01R 13/03; H01R 13/04; H01R 13/504; H01R 13/533; H01R 103/00

(52) U.S. Cl. CPC B60L 53/16; B60L 53/302; H01R 13/03; H01R 13/04; H01R 13/504; H01R 13/533; H01R 2103/00; H01R 2201/26

(57) ABSTRACT

The invention relates to a charging cable plug connector which comprises at least one or more connecting elements. The connecting element is bimetallic.

The subject matter relates to a charging cable plug connector, to a method for its production, to a charging socket, and to a system for power transmission for high-voltage applications.

One of the biggest challenges of the electrification of automobility lies in minimizing the charging times of the energy stores involved. The tank of a conventional vehicle with internal combustion engine is filled with fuel within a few minutes, which contains sufficient energy for hundreds of kilometers of driving distance. The situation is different for electrically powered vehicles, however, where an electric accumulator with a high capacity usually has to be charged at a charging station. High currents and voltages are used to charge the accumulator as quickly as possible, preferably significantly faster than it is subsequently discharged during driving operation.

In order to transfer the necessary high charging power from the charging station to the vehicle accumulator, the entire transmission path from the charging station socket via the vehicle socket to the accumulator must have very good electrical conductivity. In particular, all transitions between the individual components of the transmission path have to have particularly low transition resistances.

Despite low transition resistances, high-ohmic power losses occur, particularly at transfer points between charging stations and vehicles, i.e. particularly in charging sockets and their surroundings. This is due to the high charging currents and voltages. The resulting heat must first be absorbed by the components involved without causing damage due to overheating. Accordingly, high heat capacity of the components is necessary, and the heat must be dissipated. For this purpose, a low thermal resistance with respect to the environment is desired.

At the same time, the automotive industry is subject to strong cost pressures and a desire to keep the weight of all components used as low as possible.

The object of the invention was therefore, inter alia, to provide a particularly thermally and electrically conductive and adaptable transition between a charging socket and an energy conductor on the vehicle.

This object is achieved by a charging cable plug connector according to claim 1, a method for its production according to claim 35, a charging socket according to claim 39, and a system according to claim 41.

One aspect relates to a charging cable plug connector. The plug connector can be part of a charging socket and/or be formed on its own.

The plug connector comprises at least one connecting element made of an electrically conductive material, in particular a metal material. The connecting element can be arranged in the charging cable plug connector. Parts of the charging cable plug connector can at least partially surround the connecting element.

A longitudinal axis can be defined for a connecting element. In particular, the longitudinal axis extends substantially along the direction of the greatest spatial extension of the connecting element.

The connecting element according to the invention comprises at least two mutually opposite end faces. These can be substantially flat. It is also possible to have a surface of at least one of the end faces which deviates from a flat shape, for example a rounded shape, a pointed shape, for example a cone-shaped or a gable-shaped pointing, or another surface shape of the end faces.

An end face can constitute the end of the connecting element along the longitudinal axis. Part of the connecting element can also protrude beyond the end face.

Starting from a first end face of the connecting element, a first region of the connecting element extends to a central region of the connecting element. Starting from a second end face opposite the first end face, a second region of the connecting element extends to the central region of the connecting element.

The central region of the connecting element can have an extension in the longitudinal direction of the connecting element. The central region can comprise here parts of the first and/or the second region. The central region can also define a further region of the connecting element different from the first and second regions. The central region can substantially lie along the longitudinal axis at half the length of the connecting element. The center region can also be arranged further away from one of the front faces than from the other front face.

In addition to the first end face, the first region of the connecting element can have a further end face. This further end face can be oriented substantially facing away from the first end face. The further end face points in the direction of the second region. The further front face can be substantially flat in shape. It is also possible to have a surface of the further front face that deviates from a flat shape, for example a rounded shape, a pointed shape, in particular a cone-shaped, stepped and/or saddle roof-shaped pointing or another surface shape of the further front face.

The first region of at least one of the connecting elements is in particular formed from a first material. The second region of the at least one connecting element is in particular formed from a second material.

The first and/or the second material can in particular be an electrically conductive material. The first and/or second region of the connecting element can in particular be formed from a solid material. It is also possible that the first and/or second region of the connecting element is formed from a composite material which comprises several different components of different materials.

The first and/or the second material can in particular be a metal material. The first material is therefore also referred to as the first metal material in the following. The second material can be called the second metal material.

The first and/or second material may be, for example, copper, a copper alloy, aluminum, an aluminum alloy or combinations thereof. Metal materials such as steel, brass, gold or other comparable metal materials can also be used.

The second material may be different from the first material. In particular, the first material may be a first metal material, while the second material is a second metal material different from the first.

In a preferred embodiment, the first region of the connecting element is formed from aluminum or an aluminum alloy, while the second region of the connecting element is formed from copper or a copper alloy.

For the connecting elements, which are usually subject to particularly high electrical and thermal loads and which, for example, connect a charging socket to the vehicle's internal power supply network, solid copper elements are conventionally used. They are therefore usually connecting elements made of a single material.

On the one hand, these must be adapted to the standardized geometry of the charging boxes and, on the other hand, they must have a sufficiently high thermal capacity and conductivity. In order to meet the high requirements for heat transport and heat absorption, conventional connecting elements are often realized with a high material volume in at least one subregion. The provision of connecting elements is therefore associated with high material costs. This is even more true when solid copper is used, which is a relatively expensive metal material, for example compared to aluminum.

The complex shape of the connecting element—on the one hand adapted to charging socket geometries, on the other hand sufficiently large in volume for heat transport and heat absorption—is accompanied by complex manufacturing processes, which further increase the costs of the connecting elements in addition to the material costs.

It has been recognized that the provision of a connecting element made of two different materials, in particular two different metal materials, is advantageous.

In particular, it was recognized that not all regions of the connecting element are subjected to the same level of thermal stress. It was also recognized that heat is distributed within the connecting element, so that it is sufficient for subregions to have a high specific thermal conductivity. It was also recognized that it is sufficient for sufficient heat dissipation if subregions of the connecting element have a sufficiently high surface area.

In particular, the parts of the connecting element which serve to absorb heat and to dissipate heat do not have to be made of a material which is particularly highly electrically conductive and/or thermally conductive. It has been recognized that the shape of these regions has a major influence on their ability to transport, absorb and release heat. The choice of shape can therefore compensate for a relatively low thermal conductivity of a material.

Typically, the regions of a connecting element intended for thermal management are provided with an increased volume compared to other regions of the connecting element. It was recognized that the choice of material for these large-volume regions has a correspondingly high influence on the properties of the entire connecting element. For example, a lightweight and inexpensive material can lead to a significant reduction in the weight and cost of the entire connecting element. The regions described in this context may be identified, for example, with the first region of the connecting element according to the invention. The first region of the connecting element according to the invention can therefore be regarded, among other things, as a cooling element.

Furthermore, it was recognized that the parts of the connecting element which, due to the plug geometry of existing charging systems, have a small cross section compared to other regions of the connecting element, are advantageously made of a highly conductive material. Since these elements also come into mechanical contact with contact parts, low contact resistances are desired even at low contact pressures. By choosing a highly conductive material, excessive heating due to ohmic losses is avoided in contact regions where the conductor cross section is already small compared to the rest of the connecting element. These regions of the connecting element usually have a small volume compared to the total volume of the connecting element, in particular less than 50%. Therefore, these regions can be formed from a heavier, more expensive, highly conductive material compared to the material of other parts of the connecting element. The average properties of the connecting element will not be unduly affected by this. The region described here can, for example, be identified with the second region of the connecting element according to the invention. The second region of the connecting element according to the invention can therefore be regarded, at least among other things, as a contact region.

For the reasons mentioned above, it is therefore possible to design the connecting element from two different materials. Such a design results in a particularly inexpensive and lightweight connecting element. This is usually achieved by making one of the two materials particularly light and inexpensive. At the same time, the thermal and electrical conductivity, as well as the ability to dissipate heat, are not greatly affected.

Compared to a design of the connecting element in which only a single material is used, a sufficiently high thermal conductivity and heat dissipation capacity can be realized in every region of the connecting element at the same time. At the same time, costs and weight remain low.

Specifically, a connecting element with a second region made of copper and a first region made of aluminum can be lighter and less expensive than a connecting element made entirely of copper. If the connecting element were made exclusively of aluminum, disadvantages would arise which are avoided by the bimetallic design. The reduced thermal conductivity of aluminum compared to copper would lead to high electrical and thermal resistance, particularly in regions of the connecting element with a small cross section. The result would be strong local heating during the charging process. At the same time, the regions which are repeatedly brought into contact with conductive elements when the connecting element is used would not be able to withstand the mechanical stresses which arise. This is because aluminum is softer than, for example, the commonly used copper.

In a preferred embodiment, the first metal material may comprise aluminum or an aluminum alloy, while the second metal material may comprise copper or a copper alloy. The first region can therefore be formed from aluminum or aluminum alloys, while the second region is formed from copper or copper alloys.

The first region can therefore be used, among other things, to absorb heat and release heat into the environment. The second region can thus be used, for example, to absorb mechanical forces which occur when connecting to other elements. The second region can also serve to transfer heat to the first region due to its higher specific thermal conductivity compared to the first region. The second region can also minimize the generation of ohmic power losses by low contact resistances to contacting elements.

In a preferred embodiment, the cross section of the first region of at least one of the connecting elements is larger than the cross section of the second region of the connecting element. Alternatively, the cross sections of the two regions may substantially coincide. The region can also have a larger cross section than the first region.

The cross section of a region of a connecting element is to be determined substantially perpendicular to the longitudinal extent of the connecting element. A larger cross section leads, inter alia, to an increased material volume and thus an increased thermal capacity of the connecting element.

If a first cross section is specified greater than a second cross section, it can be understood here that the cross-sectional area of the first cross section is greater than the cross-sectional area of the second cross section. This can mean that the first cross-section has a larger diameter in at least one direction than the second cross-section. It can also be understood that the first cross section can completely surround the second cross section.

In an independently inventive embodiment, the cross section of the first region of at least one of the connecting elements can, at least in some regions, have a longer outline than the envelope of the cross section. The length of the outline can be understood as the length of the line that runs along the outline.

Likewise, the cross section can have a smaller surface area than the envelope of the cross section.

The envelope of a given two-dimensional first shape can be understood in particular as the shape which completely envelops the given first shape and is at the same time convex. The envelope is therefore convex. In a convex shape, all secants, i.e. lines between two points on the outline of the shape, lie within the shape or intersect the shape.

In particular, the cross section of the first region of at least one of the connecting elements can deviate from a convex shape at least in some regions. For example, a subregion of the cross section may be concave. Examples of at least partially concave cross-sectional shapes can be a star-shaped, lamellar, serrated, corrugated, cross-shaped, kidney-shaped, or other cross-sectional shape which is concave at least in some regions.

For example, the cross section may have at least one or more elevations. For example, the elevation may point substantially away from the center point and/or centroid of the cross section. For example, the elevation can take the shape of a spike, a triangle, a curve, a rectangle, or a combination of these.

By an at least partially concave shape of the cross section over at least a part of the first region along the longitudinal axis of the connecting element, it can be achieved that the surface area of the first region in this part is particularly large. This surface area is in particular a part of the lateral surface of the first region. In particular, the surface area may be larger than would be the case with a first region having a convex cross section of the same cross-sectional area.

In a preferred embodiment, the first region of one of the connecting elements can have at least one cooling fin. A cooling fin can be defined as a cross section of the first region as an elevation projecting radially from the first region. For example, the elevation in the cross section can be defined as the shape of a triangle, a rectangle, or a similar shape.

In one embodiment, at least one or more or even all of the cooling fins of at least one of the connecting elements can taper towards their side facing away from the first region. This ensures high stability in the transition region between the first region and the cooling fin. At the same time, tapered cooling fins are characterized by a particularly high surface-to-volume ratio in their tapered end region. This promotes the transfer of heat from the cooling fin into the environment and thus from the connecting element to the environment. The cooling fins can also have a substantially constant width without tapering.

A cooling fin can be characterized in its cross section by a large ratio between outline length and area. In particular, the ratio between the quarter of the length of the outline and the square root of the area of the cooling fin may be greater than 1.5 or 2. In another definition, for example, the major axis of the cross section of the cooling fin may be longer than the minor axis of the cross section of the cooling fin by a factor of at least 2, 3, 4, 5, 10, or more.

In one embodiment, the length of the cooling fins may vary along the circumference of the cross section of the first region. For example, the cooling fins on one side of the cross section may be shorter on average and/or in total than on the side of the cross section opposite the first side. The length of the cooling fins can be used to control the heat dissipation. The side of the first region which has longer cooling fins than another side can achieve a higher heat dissipation into the environment.

For example, cooling fins can also be arranged on only one side, for example in a circular arc portion of up to 45°, 60°, 75°, 90°, 135° or 180°. One side of the cross section of the first region can thus be free of cooling fins. For example, this side can enclose an angle of at least 180°, 225°, 270°, 285°, 300° or 315°. In

The at least one cooling fin can in particular run substantially parallel to the longitudinal axis of the connecting element.

For example, the cross section of the first region and/or the cooling fin may remain substantially constant along the entire length of the first region along the longitudinal axis of the connecting element. This provides a simple possibility of manufacturing the first region in a continuous casting process, extrusion process, or similar continuous manufacturing processes in which a product (for example a semi-finished product) is manufactured with a constant cross section along a longitudinal direction.

In one embodiment, for example, the cooling fin may extend substantially along the entire length of the first region. The cooling fin can also be interrupted along the longitudinal axis of the connecting element. The cooling fin protruding from the first region can therefore have a gap. This allows the surface area of the cooling fin to be further increased.

In one embodiment, a plurality of such cooling fins are arranged on the first region.

In a particularly preferred embodiment, cooling fins are arranged circumferentially around the first region. This may in particular mean that cooling fins protruding on all sides are provided in the cross section perpendicular to the longitudinal axis of the connecting element. For example, at least 5, 10, 15 and/or more cooling fins may be arranged on the first region.

The cooling fins can be distributed over the circumference of the first region substantially regularly, i.e. with angular ranges substantially equal to one another. The cooling fins around the first region can also be arranged at differing proximities to each other.

In a preferred embodiment, the cooling fins of at least one of the connecting elements can differ from one another in their length perpendicular to the longitudinal axis of the connecting element.

To describe the cooling fin distribution around the first region, at least two circle segments of the cross section of the first region can be defined. The circle segments are arranged around the center point, for example the geometric centroid of the cross section of the first region. For example, the first region can be halved into two semicircle segments. Other circle segments can also be defined, for example a first circle segment of 90° and a second one of 270°, which do not overlap and each define a contiguous circle segment. Also, more than two circle segments can be defined. The properties of the cooling fins can then be compared between the circle segments. The properties of the cooling fins can differ between two given circle segments.

Examples of properties of the cooling fins in a circle segment are the length of the longest cooling fin, the surface area of the largest cooling fin, the number of cooling fins, the average length of the cooling fins, the average cross-sectional area of the cooling fins, the average outline length of the cooling fins.

For the sake of simplicity, the cross section of the first region of the connecting element according to the invention can now be divided into two circle segments, a first and a second, each spanning 180° and not overlapping each other. In this case, the two circle segments are semicircles. In fact, the cooling fins in cross section for at least one such division of the cross section of the first region of the connecting element in the first circle segment can be more numerous, longer, have a higher surface area and/or be longer in their outline than the cooling fins in the second circle segment.

The properties length, surface area, outline length can be averaged or summed over the cooling fins in the respective circle segments, for example.

The demarcation between each cooling fin and the rest of the first region of the connecting element in the cross section can, for example, be made such that the cross section of the first region is filled with a convex surface with a maximum area. The convex surface is completely contained within the cross section of the first region. The convex surface and the outline of the cross section touch at two or more points. The parts of the cross section of the first region which do not lie within this convex surface can be considered as cooling fins. This definition of a cooling fin in cross section can be used for all aspects of the subject matter.

The cross section of the first region can be shaped by dimensioning the cooling fins. In this context, the envelope of the cross section of the first region can again be considered. By using differently long, wide, spaced apart or otherwise different cooling fins, an asymmetrical shape of the envelope can be achieved. In particular, this can be an asymmetrical, rotationally asymmetrical, axially asymmetrical shape, or other shape deviating from a symmetrical shape of the envelope.

The actual cross section of the first region can also be considered in this context. This can also have an asymmetrical shape due to the cooling fins differing in length. In particular, the cross section may have an asymmetrical, rotationally asymmetrical, axially asymmetrical shape or other shape deviating from a symmetrical shape.

The cross section of the first region can be greater than the cross section of the second region. The cross section must be determined substantially perpendicular to the longitudinal extension of the connecting element. A larger cross section leads, inter alia, to an increased material volume and thus an increased thermal capacity of the connecting element.

The cross section of the first region of at least one of the connecting elements can be substantially constant along the longitudinal axis of the connecting element. The cross section of the second region of at least one of the connecting elements, in particular of the connecting element, can be substantially constant along the longitudinal axis of the connecting element.

A plug-in direction can be defined for a connecting element. This can in particular be defined substantially parallel to the longitudinal axis of the connecting element and can extend from the first region to the second region of the connecting element.

A first fastening element can be arranged in the first end face of the connecting element.

The first fastening element can in particular be shaped as a first recess. The recess can be suitable for accommodating a connecting key bolt. The first recess can extend parallel to the longitudinal axis of the connecting element in the direction of the central region of the connecting element. The first recess can have a substantially round cross section; but the cross section can also be elliptical, angular, in particular triangular, quadrangular, pentagonal or polygonal in shape.

The cross section of the first recess can be substantially constant along the longitudinal axis. The cross section can also taper, in particular along the longitudinal axis in the direction of the central region of the connecting element, in particular linearly, so that the cross section decreases linearly with increasing penetration depth of the first recess into the first region of the plug connector. The cross section of a first recess can decrease uniformly at all sides perpendicular to the extension direction of the first recess, for example perpendicular to the longitudinal axis of the connecting element. The cross section can also decrease more strongly in a direction perpendicular to the longitudinal axis than in another direction. In particular, an asymmetry of the first recess can be achieved in this way, which makes it possible to insert a correspondingly shaped pin only in one angular position about the longitudinal axis of the connecting element.

In a preferred embodiment, the first recess is conically shaped.

The first fastening element can be, for example, a blind hole, in particular with an internal thread. The blind hole can extend from the end face into the connecting element.

A blind hole can also be provided in the first recess of at least one of the connecting elements. In particular, a thread can be provided in the blind hole. The blind hole can end in the first region. In some cases, it is also possible for the blind hole to protrude into the second region. The blind hole, in particular with thread, allows for a fixed screw connection of an attachment element such as a connecting pin in the first recess. A high contact pressure between the pin and first recess can be achieved. A particularly low-resistance transition between a connecting pin and the connecting element can thus be produced.

As an alternative to a recess, the first fastening element can also be a pin, a threaded pin and/or an eyelet or another fastening element, in particular pointing away from the end face. The fastening element can, for example, extend in the longitudinal direction of the connecting element.

An attachment element can be fastened to the connecting element. For example, the attachment element can be a connecting pin. The attachment element can also be, for example, a busbar and/or a cable lug. In particular, the first region of the connecting element can be used to connect an attachment element thereto. If, for example, the connecting element has a recess with an internal thread, an attachment element which has a through-hole can be connected, in particular screwed, thereto.

The connecting element can be connected to the attachment element in different ways. These are, as exemplified above, a positive connection, for example by means of a screw connection. A materially bonded connection is also possible, for example by means of welding, a soldering process, or other material-to-material joining processes.

In particular in combination with a tapered, in particular conical recess, a connecting key bolt, which is also tapered and in particular conical, can be permanently connected in the recess by means of the thread in the blind hole and a screw in a firm and well-conducting manner.

In a preferred embodiment, the connecting element has a second fastening element on its second end face.

The second fastening element can, for example, be a second recess. The second recess can be provided on the connecting element without the presence of the first recess described above. The second recess can taper in particular towards the central region. The second recess can also have a substantially constant cross section along the longitudinal axis of the connecting element. The second recess can also have a thread, in particular an internal thread, for example on the inner surface of the second recess. In a further embodiment, at least one or more spring contacts can be provided, in particular in the second recess.

The second fastening means can, for example, be a pin, threaded pin or the like as an alternative to a second recess. In particular, the second region itself can act as a pin.

The second region of at least one of the connecting elements can be shaped as a pin, for example.

The second region of at least one of the connecting elements can be shaped as a socket, in particular as a sleeve with a base. For example, the socket can have an opening. The opening can be shaped as the second recess described above.

For example, a guide tip can be arranged on the second region, in particular the second end face. A guide tip can extend beyond the second end face in the direction of the longitudinal axis of the connecting element. The guide tip has a smaller diameter than the region of the second region on the side of the end face facing away from the guide tip. In particular, the guide tip may have a protrusion, in particular a thickening and/or an indentation, in particular a circumferential thickening and/or indentation. A thickening and/or indentation can be used to fasten an element to the guide tip.

In particular, a cap made of a non-conductive material can be arranged on the end face of the second region, in particular on the guide tip. In particular, this cap can be arranged with a positive and/or non-positive connection on the second region, in particular on the guide tip. In particular, an indentation and/or thickening of the guide tip can engage in a thickening and/or indentation of the cap. The cap can be made, for example, from plastics material, silicone, and/or another non-conductive material. In particular, the cap can have substantially the same cross section, at least in the transition to the second region, as the region of the connecting element adjacent to the cap. This prevents an edge at the transition between the cap and connecting element. The cap can also have a smaller cross section than the second region of the connecting element in the region of the connecting element adjacent to the cap. The end face of the cap facing away from the connecting element can be substantially flat; a rounded shape of the end face can also be provided.

The plug connector according to the invention can function as part of a plug as well as part of a socket. Both the first region and the second region can each be shaped as a recess and/or as a plug-in element.

According to one exemplary embodiment, the first region of at least one of the connecting elements can be extruded. For example, the cross-sectional shape of the first region of the connecting element can be defined. In this way, for example, a cross section with one or more cooling fins can be achieved.

The production of a region, in particular the first region, of at least one of the connecting elements in this way allows for a particularly favorable method of production. It was recognized that the first region requires little or substantially no variation of the cross section along the longitudinal axis of the connecting element. Accordingly, a manufacturing method as mentioned above is suitable for producing in a favorable manner a first region with a complex cross section which is substantially constant along the longitudinal axis of the connecting element.

In a preferred embodiment, the second region of at least one of the connecting elements can be cast, deep drawn and/or cold extruded.

In concrete terms, it was recognized that the second region of the connecting element must be able to be regularly connected to the standardized connection geometry of charging plugs. Therefore, the second region of the connecting element often has to have a complex shape which can change along the longitudinal axis of the connecting element. Extrusion, which is suitable for the first region, is therefore less suitable for the second region of the connecting element. Instead, one of the above manufacturing methods can be used to realize the complex shape. Also, the material of the second region will often be chosen to be harder than that of the second region. For example, the second region can be made of copper and the first region of aluminum. Even for such hard materials, the methods mentioned above for the second region are more suitable than those mentioned for the first region.

In one exemplary embodiment, the first region and the second region of at least one of the connecting elements can be integrally connected to the first region of the connecting element. In particular, the connection between the first and second region of the connecting element can be realized by means of a welding zone. The welding zone can in particular be a friction welding zone, in particular a rotary friction welding zone and/or an ultrasonic welding zone, and/or a resistance welding zone.

The material connection—in particular welded connection—between the first and second regions of the connecting element ensures particularly good thermal and electrical conductivity between the two regions. In particular, the thermal conductivity is of great importance, since heat which is generated in one of the two regions, for example the second region, must be transported to the other of the two regions, for example the first region. The heat transport within the connecting element allows for increased overall heat absorption capacity. The heat transport between different regions of the connecting element can also be particularly favorable if one region is particularly suitable for dissipating heat. For example, the first region can be particularly suitable for dissipating heat into the environment due to an increased cross section or cooling fins. If heat is generated in the second region, it must reach the first region as unhindered as possible in order to be dissipated there. The material connection between the two regions allows this with particularly low thermal resistance, and is therefore particularly beneficial for the function of the connecting element according to the invention.

It was found that a two-part production with different materials is surprisingly less expensive than a single-part production from a continuous solid material. It was recognized that often at least one of the two regions of the connecting element takes on a shape that is simple in itself. Thus, at least for this one region, a very inexpensive production as a mass product can be chosen. Surprisingly, the additional step of welding is more than offset by the simplified production of the regions of the connecting element, which now have to be produced separately from one another.

The first and/or the second region of at least one of the connecting elements can be formed from a solid material.

The second region of at least one of the connecting elements can have, at least in some regions or entirely, a smaller cross section than the first region of the connecting element.

A central axis can be defined for a region of the connecting element. This axis can extend, for example, parallel to the longitudinal axis of the connecting element. In particular, the central axis can extend through a center and/or near a center of at least part of the cross sections of the relevant region of the connecting element. The cross section here is a section perpendicular to the longitudinal axis of the connecting element and/or perpendicular to the longitudinal axis of the corresponding region of the connecting element whose cross section is being determined. For example, the center of the cross section can be defined as the geometric center of mass of the cross section.

The center of the cross section can also be determined, for example, as the center of the envelope of the cross section.

For example, if the first region comprises cooling fins, the central axis can be shifted with changes in the cooling fin length.

A central axis can be defined for the first region and also for the second region of the connecting element.

The second region can be connected centrally to the first region. For example, the central axes of the first region and the second region can substantially coincide with one another. The second region can also be arranged eccentrically on the first region. This can mean, for example, that the central axis of the second region is spaced apart from the central axis of the first region, in particular perpendicular to the central axis of at least one of the regions and/or perpendicular to the longitudinal axis of the plug-in bolt and/or one of the regions of the plug-in bolt.

If the first region has cooling fins, these can, for example, be shorter on the side of the first region to which the second region is displaced than on other sides of the first region. Cooling fins can also be arranged only on the side of the first region further away from the second region. In this way, the dissipation of heat can be directed to the side which is further away from the second region.

In one exemplary embodiment, in at least one of the connecting elements, the first fastening element, for example the first recess which is arranged in the first end face, can be arranged eccentrically to the central axis of the first region.

The recess in the first region of a connecting element can therefore also be arranged eccentrically to the central axis of the first region in the first region of the connecting element. In this way, similar to the eccentric positioning of the second region on the first region, an adaptation to a predetermined spacing of attachment elements, such as connecting pins, can be achieved. The distance between any elements positioned in the recess can also be adjusted. In particular, the recess of at least one connecting element can be offset eccentrically outwards in the first region, so that it is at a greater distance from another connecting element of the charging cable plug connector than it would be in a central arrangement.

The recess and the second region can be offset in substantially the same direction relative to the central axis of the first region. These two can also be offset in different directions, particularly in opposite directions. For example, the second region of a connecting element can be approximated to another connecting element of the charging cable plug connector by its eccentric arrangement on the first region, while the recess is spaced apart from the other connecting element by its eccentric arrangement on the first region of the connecting element.

In addition to the first end face, the first region of the connecting element can have a further end face. This further end face can be oriented substantially facing away from the first end face. The further end face points in the direction of the second region. The further front face can be substantially flat in shape. It is also possible to have a surface of the further front face that deviates from a flat shape, for example a rounded shape, a pointed shape, in particular a cone-shaped, stepped and/or saddle roof-shaped pointing or another surface shape of the further front face.

In one embodiment, at least one of the connecting elements is at least partially coated. In particular, a metal coating can be advantageous in order, for example, to avoid contact corrosion, to reduce transition resistances and/or to make the plug connector more durable. For example, a connecting element can be plated with silver, gold, copper, aluminum, nickel, and/or further metals and/or alloys thereof. The coating can substantially completely cover the connecting elements or can be applied only to selected regions. For example, a coating can be applied in the first recess and/or in the second region of the connecting element. It is also possible to provide a plug pin at least partially with a double coating, for example with an inner nickel layer and an outer silver layer.

In one embodiment, the second region is silver plated nickel, while the first region is merely silver plated.

In one embodiment, the coating of at least one of the connecting elements is arranged only on the second region of the connecting element. The connecting element can also be substantially completely coated.

For example, the second region can be formed from copper or a copper alloy and coated with a coating, for example a silver coating, for example a nickel silver coating.

The first region can be free of a coating or coated with a different coating than the second region.

The first region can, for example, only be coated in the region of a fastening element. For example, the first region can be coated in the region of the first recess. The remaining regions of the first region can, for example, be free of a coating.

The second region of at least one of the connecting elements can, for example, have at least partially a round cross section, an oval, elliptical, angular, in particular triangular, quadrangular, polygonal or otherwise shaped cross section. The cross section of the second region can be substantially constant along the longitudinal axis. The cross section of the second region can also vary. In particular, the cross-section of the second region can increase, for example in steps, towards the center region, in particular in the center region.

In particular, the cross-section of the second region can therefore have an increased cross-section in the center region, in the transition to the first region. This increases the mechanical stability of the transition. An indentation, for example a circumferential groove, can also be provided in the central region. In particular, a seal, for example a sealing ring, can be provided around the second region, in particular in the region of the increased cross section, in particular in the circumferential groove.

The plug connector according to the invention can comprise a housing.

The housing can be made of a non-conductive material. For example, the housing can be molded from a plastics material, in particular from a plastics material which is suitable for high temperatures and/or has a high thermal conductivity (high-temperature plastic). For example, polyamidimide, polysulfone, polyethersulfone, PA6GF15, UL94, or a similar heat-resistant plastics material can be used. The housing can also be at least partially formed from other non-conductive materials such as ceramic or glass.

The housing of the charging cable plug connector and/or the housing of the charging socket can be formed in one piece, for example molded and/or injection-molded. It is also possible that the housing is made up of several parts. The individual parts can, for example, be screwed, glued, welded or fastened to one another and/or other elements in some other manner.

Any seals arranged on the charging cable plug connector and/or the charging socket can, for example, be produced in a two-component injection molding process together with other parts of the respective housing. Seals can also be arranged as separate components on the housing.

The charging cable plug connector can comprise a single connecting element. The charging cable plug connector can also have at least two connecting elements.

The connecting elements of the charging cable plug connector can be fixed in the housing relative to each other and/or relative to the housing. In particular, the connecting elements can be fixed in such a way that the longitudinal axes of at least two connecting elements are substantially parallel to one another. The housing can fix the plug-in pins in such a way that they cannot move relative to one another without deforming and/or damaging the housing.

In the case of an eccentric arrangement of the second region on the first region of the at least one connecting element, it is possible, particularly in an arrangement comprising two or more connecting elements, for the central axes of the first regions to be further apart than the central axes of the second regions. The central axes of the second regions can also be further apart than the central axes of the first regions.

A distance between two axes, particularly center axes, can be defined as the shortest possible connection between two axes.

The central axes of the second regions of at least two connecting elements can both be spaced apart from the central axis of the first region of the relevant connecting element. It is also possible for only the second region of one of the connecting elements to be arranged eccentrically on the first region of the connecting element, while the other connecting element or pins have a first and a second region each having a substantially identical central axis.

The central axes of the first regions and the second regions of the at least two connecting elements can lie substantially in a common plane.

The central axes of the second regions can be at a smaller distance from one another than the central axes of the first regions of the at least two connecting elements.

The central axis of the first region and that of the second region can be parallel to one another. The two central axes can also be tilted relative to one another.

An eccentric arrangement of the second region on the first region enables not only better heat dissipation and stress resistance, but in particular also a relative positioning of the center axes of the two regions (of the first and second) to one another. In particular, part of an adaptation between two different plug-in geometries can be achieved in this manner. One plug-in geometry can be connected on the side of the second regions, another on the side of the first region of the connecting elements. An eccentric arrangement can compensate for different distances between connection points on the sides of the first region and the second region.

The geometric spacings within the charging cable plug connector can also be influenced by the eccentric arrangement of the second region on the first region. By means of the eccentric arrangement of the second region on the first region, the second region of a first connecting element can be moved closer to or away from at least one other connecting element without changing the relative position of the first regions of the connecting elements to one another. The same applies vice versa for the position of the second regions of the connecting elements. By an eccentric arrangement, the second region of a first connecting element can for example be spaced as far as possible from the second connecting element, in particular from the second region of the second connecting element. The second region of a first connecting element can also be brought as close as possible to the at least one further connecting element of the plug connector.

Similarly, it is possible to vary the distance of the first regions from one another by the eccentric arrangement of the second region on the first region while keeping the distance between the first regions substantially constant. The first regions can also be approximated or spaced apart in this manner.

In a preferred embodiment, the second regions of the at least two connecting elements are each arranged eccentrically in the direction of the other connecting element(s). In this way, for a given distance of the second regions from one another, the first regions are spaced apart as far apart from one another as possible. In other words, for a given distance of the first regions, the second regions have the smallest possible distance from one another.

The at least two connecting elements are spaced apart from one another in the charging cable plug connector. In particular, the connecting elements are spaced apart from one another substantially perpendicular to the longitudinal axis of at least one of the connecting elements.

The longitudinal axes of the connecting elements are substantially parallel to one another. The plug-in directions of the connecting elements can also be substantially parallel to one another. The plug-in directions and/or longitudinal axes can also be tilted in relation to one another.

Due to the eccentric arrangement of the second regions of the at least two connecting elements, the second regions of the connecting elements can approximate one another while maintaining the same distance between the first regions. The second regions can also be spaced apart from one another by the eccentric arrangement. For a given plug face, in particular due to the smaller distance of the central axes of the second regions from one another compared to the distance of the central axes of the first regions from one another, it can be achieved that heat can be dissipated as well as possible via the first regions. The spacing of the first regions results in a low accumulation of heat between the connecting elements. The recesses of the first regions can also be spaced apart as far apart from one another as possible, which further results in a spatial distribution of warm elements.

If cooling fins are arranged on the first region of at least one of the connecting elements, they can only be arranged on a side which faces away from the at least one further connecting element. The side of the first region which faces the at least one further connecting element can therefore be free of cooling fins. Also, the cooling fins of the first region can be arranged substantially on all sides of the first region. In this case, for example, the cooling fins which point away from the at least one further connecting element can be more numerous, longer, have a larger surface area and/or a larger volume than the cooling fins which point away from the at least one further connecting element. The cooling fins can also be substantially the same length.

If at least two connecting elements have cooling fins in their respective first regions, these can be designed to be more numerous, longer, with a higher surface area and/or with a higher volume on the side of the first region facing away from the at least one further connecting element than on the side facing the other connecting elements.

In the case of longer, higher surface area and/or higher-volume cooling fins on a first side than on a second side, this may mean here and in all other embodiments that the cooling fins are longer and/or higher-volume on average over the corresponding side and/or in their total over the respective sides.

The two sides of the first region of a first connecting element can be defined by placing a plane through the central axis of the first region, which is aligned parallel to the central axis and perpendicular to the distance vector from the central axis of the first region of the first connecting element to the central axis of a first region of a second connecting element. The plane thus defined divides the first region of the first connecting element into a side facing the second connecting element and a side facing away from the second connecting element. In the cross-sectional view of the first region of the connecting element, these two sides are each circle segments of 180°, which do not overlap each other.

For example, cooling fins can also be arranged only on the side facing away from the at least one further connecting element.

By varying the cooling fin distribution between different sides of the first region of at least one of the connecting elements, the heat dissipation can be controlled in the desired direction. In the case of a plurality of connecting elements, the heat can be dissipated in particular in directions which point away from the other connecting elements.

The cooling fins of at least one of the connecting elements can thus be arranged in an asymmetrical manner around the first region of the connecting element. Asymmetrical can in particular be point asymmetrical, rotationally asymmetrical, axially asymmetrical or asymmetrical in some other way. Here and in the rest of the description, a specific “a”symmetry such as a point asymmetry indicates that the corresponding symmetry does not exist, for example no point symmetry. This serves to optimize the heat transport out of the charging cable plug connector according to the invention.

The first and/or the second end faces of the connecting elements can be substantially flush with one another in the longitudinal direction. The end faces can therefore be aligned with one another in a direction perpendicular to the longitudinal axis, central axis, and/or plug-in direction of at least one of the connecting elements. The connecting elements can also be offset from one another along the longitudinal axis.

In particular, the connecting elements can be of the same length. Different lengths are also possible. For example, the first regions of at least two connecting elements can have different lengths, in particular such that the recesses are offset from one another along the longitudinal axis, while at least some of the remaining regions of the connecting elements, for example the second end faces, are not offset from one another along the longitudinal axis.

In one embodiment, the at least two connecting elements of the plug connector are substantially identical in shape. In another embodiment, the connecting elements are constructed substantially mirror-symmetrically to one another. The imaginary mirror surface on which the connecting elements are mirrored can in particular run parallel to the longitudinal direction of at least one of the connecting elements.

The housing can fix the at least two connecting elements to one another. For this purpose, the housing at least partially encloses the connecting elements. In particular, the housing can engage with the outer lateral surfaces of the first regions of the connecting elements. The housing can rest on the lateral surfaces of the first regions of the connecting elements. In particular, the housing encloses the first regions of the connecting elements substantially over their entire surface. If the lateral surfaces have elevations and/or indentations, the housing can engage in the indentations in particular. The lateral surfaces of the first regions provide a large access surface for the housing. Since the first region is preferably in contact with another current-carrying element via the recess, the lateral surface also does not fulfill an electrically conductive function and can be covered with the housing. In addition to the mechanical fixing of the connecting elements, this thus also serves to electrically insulate the first region. In particular, the housing serves to electrically insulate the connecting elements from one another.

The cooling fins can provide improved anchoring of the connecting elements in the housing. This is already achieved by the increased surface area of the lateral surface. The engagement of the housing in the gaps between the cooling fins also improves the quality of the connection between the connecting elements and the housing.

The housing of the charging cable plug connector can have openings, as already mentioned above. These at least allow contact to be made with the recess in the end face of the first region of at least the connecting elements. In one embodiment, the housing has an opening in the region of the first end face of at least one of the connecting elements. In particular, the first end face can be completely exposed by an opening of the housing. In one embodiment, the housing terminates substantially flush with the first end face of at least one connecting element. It is also possible for the housing to project beyond the first end face in the longitudinal direction. The first end face can also substantially be completely covered by the housing, so that only the access for receiving at least one connecting element remains. This can have the advantage that, after an attachment element, for example of a connecting pin, has been connected in the recess, few conductive surfaces are openly accessible.

An opening in the housing is also to be provided, which allows at least parts of the second region of the connecting elements to make contact. The housing can have, for at least one, preferably for all the connecting elements, an opening on the side of the housing and/or of the corresponding connecting element opposite the first end face. This allows the second region of the connecting element to be contacted. As already shown above, a further end face of the first region can be identified, which is different from the first end face of the connecting element. This is an end face which points toward the second region of the corresponding connecting element to which the first region belongs. In some embodiments of the housing, this further end face is also at least partially exposed through an opening in the housing. In particular, the housing can be substantially flush with the further end face of the first region. It is also possible for the housing to point at least partially beyond the further end face in the longitudinal direction, in the direction of the second region. It is also possible to cover the further end face of the first region substantially completely with the housing.

The charging cable plug connector can form a receptacle for a charging plug. The charging cable plug connector can also form part of a charging plug. Such a charging plug can be, for example, a Mode-2, Mode-3, Type-1 or Type-2 plug. In particular, the plug can have connections for charging via direct current. For example, the plug can be a Combined Charging System (CCS), CHAdeMO, a Tesla® Supercharger plug, or another plug with direct current contacts.

It is understood that the first region and equally the second region can each serve as a plug-in element and/or as a receptacle.

A further aspect relates to a method according to claim 35 for producing a connecting element for a charging cable plug connector.

The method comprises in particular providing a first region made of a first metal material. The first region may in particular have been obtained beforehand by means of extrusion. The production method for the charging cable plug connector can in particular also comprise the step of extrusion. The semi-finished product obtained in this way can, for example, be a long strand with, for example, a constant cross section along its length. For example, the semi-finished product can be made of aluminum. The first region can in particular be cut to length. For example, the first region can have been cut to length from a semi-finished product produced as described above; the cutting to length can be part of the production method. Cutting to length can be achieved by sawing, punching, laser cutting, vaporizing or similar methods.

In particular, at least one or more cooling fins of the first region can be obtained by the extrusion. For example, a semi-finished product obtained in this way may already have the cooling fins.

In particular, the method further comprises providing a second region made of a second metal material. The second region was previously obtained by casting, deep drawing and/or cold extrusion. This production process of the second region can be part of the production method.

The first and/or second region can be further coated. The coating of the first and/or second region can be carried out independently of the other region.

In particular, the method further comprises a material bonding of an end face of the first region to an end face of the second region. The material bonding can in particular be welding. The end face of the first region at which the joining is carried out can in particular be the further end face of the first region.

For example, welding can be achieved by friction welding. In particular, rotational friction welding can be used as a method, wherein in particular the second region is set in rotation and is rotationally friction welded to the first region. The first region can, for example, be fixed. In a further embodiment of the method according to the present aspect, the welding is carried out by means of ultrasonic welding.

Alternatively or additionally, welding can be carried out by means of resistance welding.

A possible coating of at least part of the connecting element can be carried out before bonding. Alternatively or additionally, the coating can be carried out after bonding. For example, it may be advantageous to coat the second region before connecting it to the first region.

In one embodiment, the second region can be made of a copper material, in particular of copper or alloys. In this case, the second region can be silver plated, for example silver-plated over nickel.

Coating before joining the two regions of the connecting element has the advantage that selective coating of one of the two regions is possible without having to mask the other region.

The bonded connecting element can also be coated as a whole, in particular silver-plated. For example, the second region can first be provided with a first coating, for example with nickel. After joining, the entire connecting element can then be silver plated.

The individual steps mentioned can be carried out in the order mentioned above. The steps of the method can also be carried out in a permuted order one after the other and/or at least partly simultaneously.

Before and/or after joining the first and second regions, a first and/or a recess can be created in the first and/or the second region.

The method can further comprise the step of enclosing at least one connecting element or a plurality of connecting elements, for example two connecting elements, in a housing. For example, the connecting elements can be cast and/or overmolded.

A further aspect relates to a charging socket according to claim 39.

The charging socket can have a connector receptacle, which can be arranged particularly on the back of the charging socket. The plug connector receptacle can be suitable for the insertion of the charging cable plug connector. The plug connector receptacle can comprise a recess in the charging socket, in particular in the housing of the charging socket. In particular, the plug connector receptacle can be at least partially substantially cross-sectionally adapted to a charging cable plug connector.

The charging socket can also comprise a bearing surface for the charging cable plug connector. The plug connector can rest at least partially on the bearing surface. The bearing surface can be arranged on the housing of the charging socket, for example. The contact surface can, for example, be arranged around the plug-in pins and/or around the plug connector receptacle. The bearing surface can also be arranged at least partially on the collar.

Retaining means for the charging cable plug connector can be provided on the charging socket, for example form-fit and/or force-fit retaining means, for example hooks, threads for screws, in particular threads embedded in the housing of the charging socket, in particular made of a metal material, or similar retaining means. In particular, the retaining means can be arranged in the region of the plug connector receptacle, for example in the plug connector receptacle or in a region around the plug connector receptacle. The retaining means can be used to connect a charging cable plug connector to the charging socket. For example, this connector can be fastened to the charging socket by means of at least one, preferably two, three, or four or more screws.

In particular, the charging cable plug connector can be connected to the charging socket with a positive and/or non-positive connection.

At least one seal can be arranged on at least parts of the plug connector receptacle and/or the bearing surface. For example, the seal can be arranged in a closed shape, for example in a ring, rectangle, oval or other closed shape on the plug connector receptacle and/or the bearing surface. The seal can enclose at least part of the plug connector receptacle. The seal can be manufactured, for example, from an elastic material, in particular from a plastic, rubber, silicone, or similar materials. Such a seal can be arranged on the plug connector.

The charging socket according to the invention comprises at least one receptacle for a charging plug. The receptacle is located on the front side. The charging plug can originate, for example, from a charging station. This can be, for example, a Mode-2, Mode-3, Type-1 or Type-2 plug. In particular, the plug can have connections for charging via direct current. For example, the plug can be a Combined Charging System (CCS), CHAdeMO, a Tesla® Supercharger plug, or another plug with direct current contacts.

Another aspect relates to a system according to claim 41.

The system comprises a charging socket of the subject matter. This can be connected to a charging cable plug connector of the invention. In particular, the charging cable plug connector can be arranged at least partially in the charging socket, in particular in the plug connector receptacle of the charging socket. In particular, the plug connector can be arranged in the charging socket in such a way that at least one of the at least two second regions of the connecting elements is arranged at least partially in the receptacle of the charging socket. In particular, the charging cable plug connector can be in contact circumferentially around at least one of the connecting elements with the charging socket, for example in a contact region of the charging socket. The housing of the charging cable plug connector can make direct contact with the charging socket and/or a seal can be arranged between the two, via which the charging cable plug connector makes indirect contact with the charging socket. The charging socket and charging cable plug connector can be connected to one another by force-fit and/or form-fit. In particular, the housing of the charging cable plug connector can be connected to the charging socket, in particular to the housing of the charging socket. In particular, the two can be screwed together.

The charging socket according to the invention, the charging cable plug connector according to the invention and/or the system according to the invention may be suitable for being connected to an attachment part. The connection part can be arranged on the rear side of the charging socket, for example. The connecting part can also be arranged at least partially inside the charging socket.

The attachment part can in particular comprise a busbar. In particular, the busbar has a substantially rectangular cross section. The cross section can have two mutually opposite and substantially parallel wide sides and two narrow sides arranged substantially perpendicular thereto, substantially parallel to one another and opposite one another. The busbar has at least partially a longitudinal axis which is substantially perpendicular to both the narrow and wide sides. The wide side is wider perpendicular to the longitudinal axis than the narrow side.

The busbar can, for example, comprise a connecting pin. The connecting pin can in particular engage with the first region of at least one of the connecting elements. For example, the connecting pin can have a shape congruent with the first recess of at least one of the connecting elements. For example, the connecting pin can taper, in particular so that the connecting pin is conically shaped. The connecting pin can, for example, have a through-hole in the longitudinal direction. The connecting pin and thus in particular the busbar can be screwed to the connecting element through the through-hole.

The attachment part, in particular the busbar, can also have a through-hole, for example. For example, the busbar can be screwed to the connecting element using a screw. For this purpose, the connecting element can, for example, have a receptacle with an internal thread.

The attachment part can also be a cable lug, for example, in particular with a through-hole.

The subject matter is explained in more detail below with the aid of a drawing showing an embodiment. In the drawing:

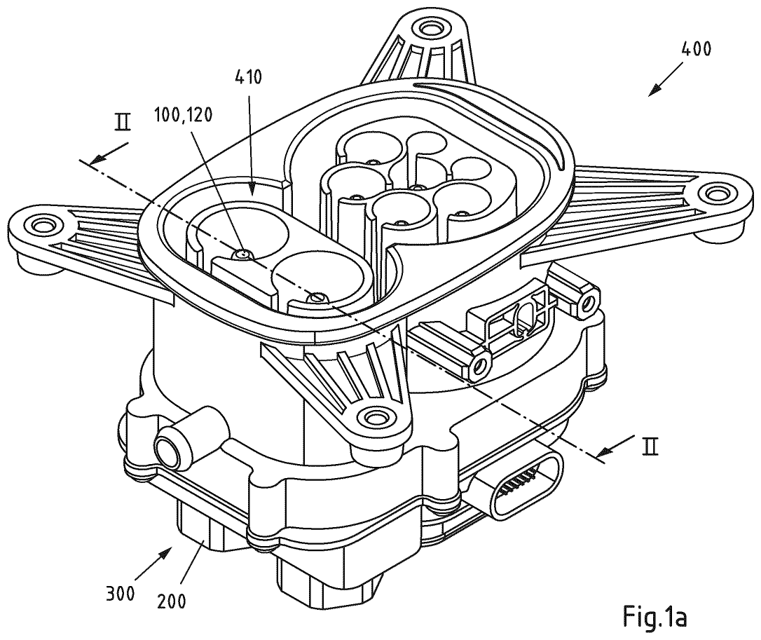

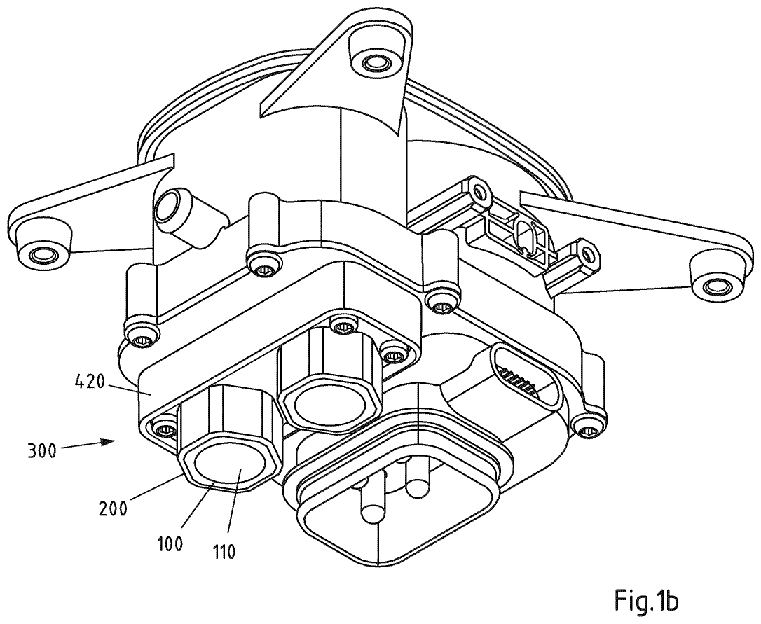

FIG. 1a, b show an isometric view from two angles of a charging socket with charging cable plug connector according to an exemplary embodiment;

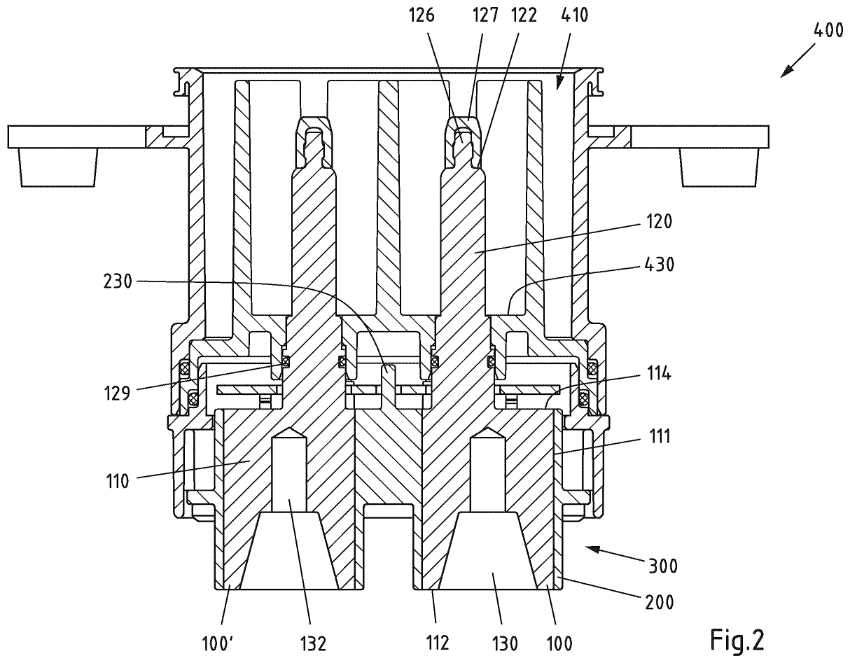

FIG. 2 shows a lateral sectional view of a charging socket with charging cable plug connector according to an exemplary embodiment;

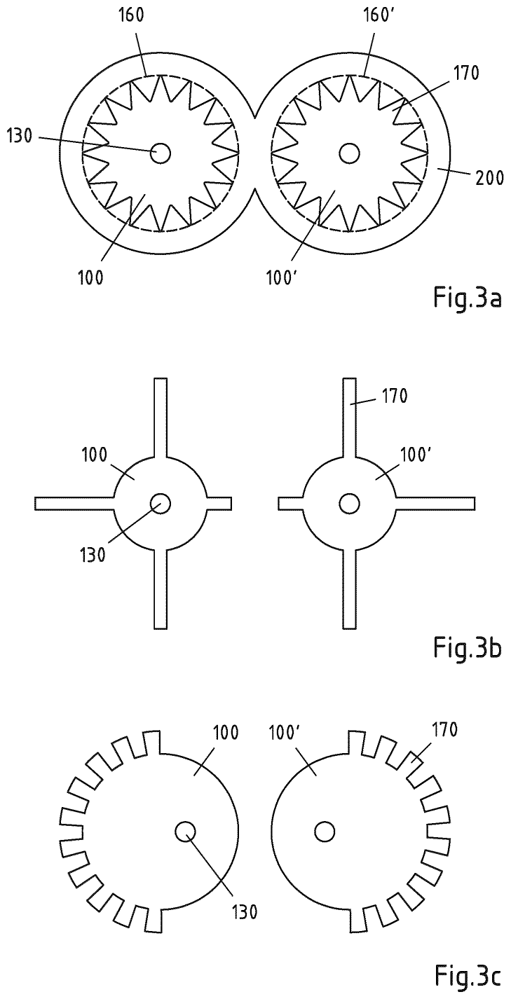

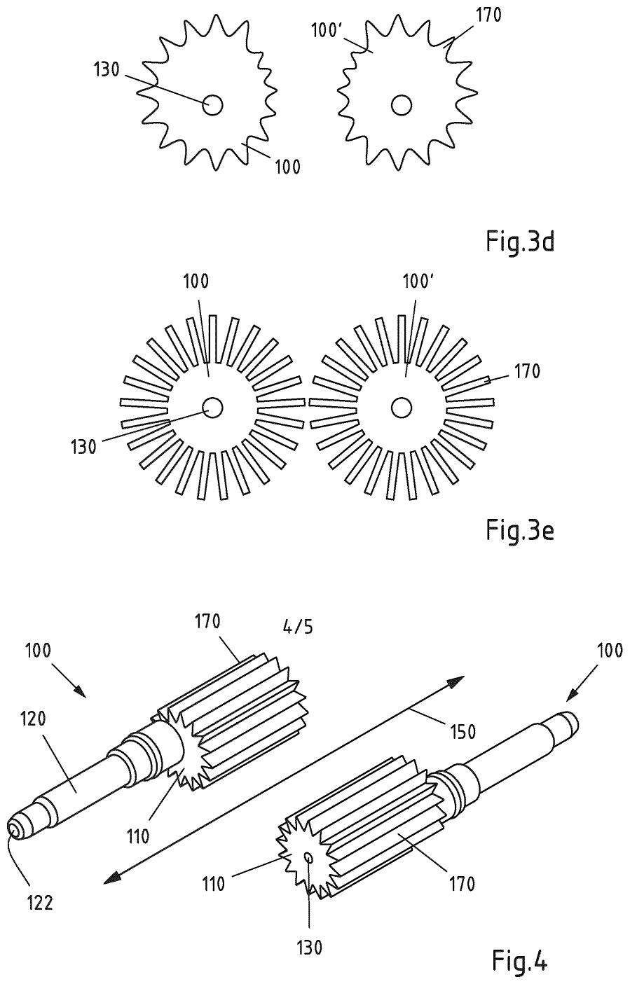

FIG. 3a-e show various connecting elements and charging cable plug connectors according to the invention according to exemplary embodiments;

FIG. 4 shows an isometric view of a connecting element according to the invention according to an exemplary embodiment;

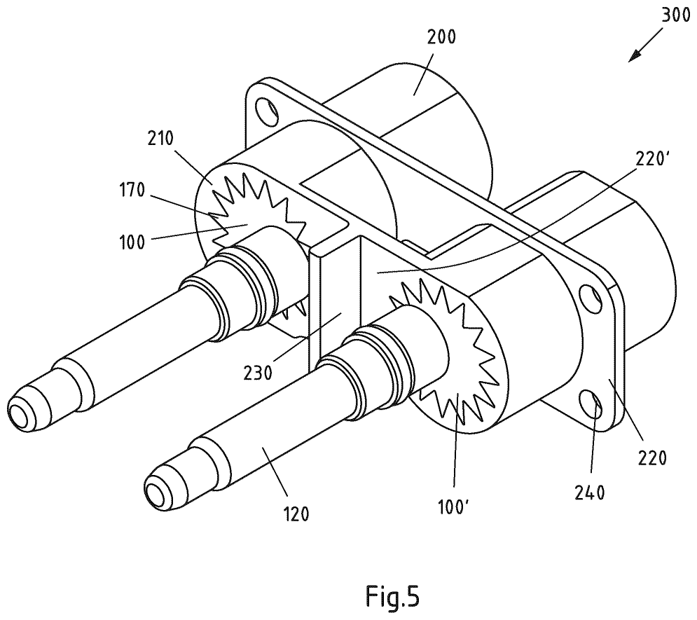

FIG. 5 shows the charging cable plug connector according to the invention according to an exemplary embodiment;

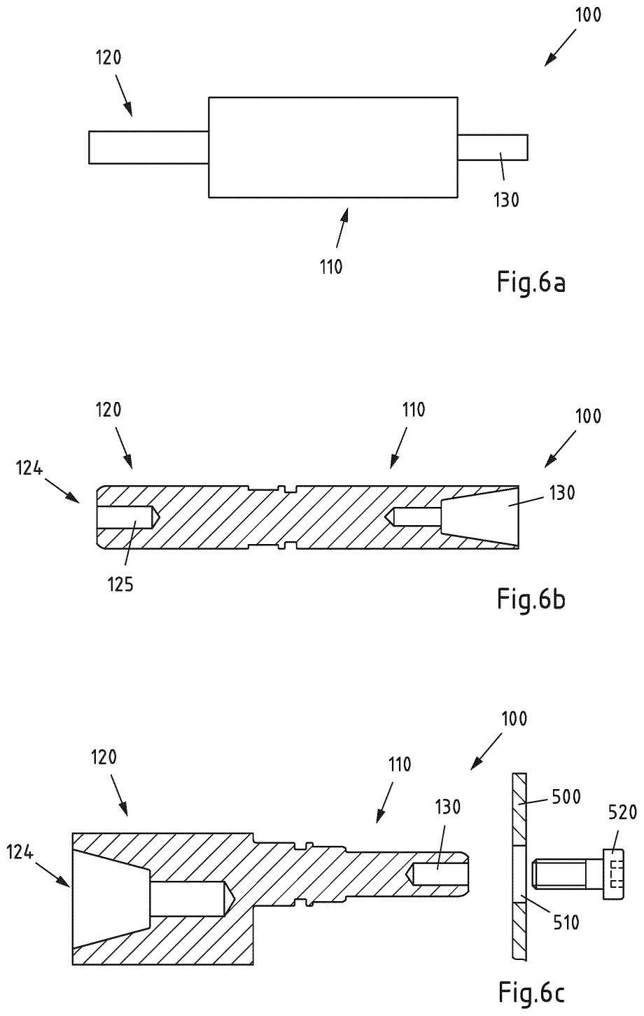

FIG. 6a-c show sectional views of connecting elements according to the invention according to exemplary embodiments;

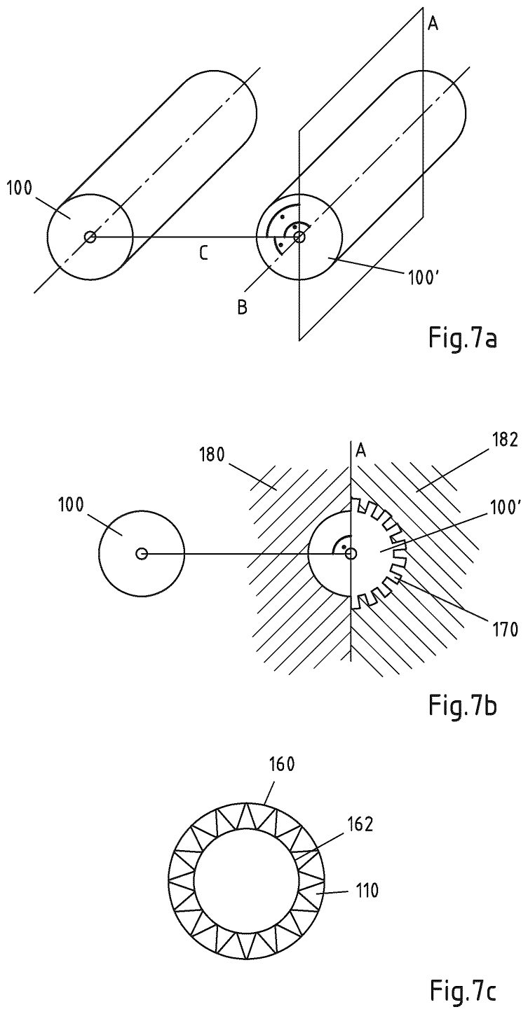

FIG. 7a-c show schematic representations of the two sides of the cross section of the first region of a connecting element according to the invention according to an exemplary embodiment, and an example of a definition of the cooling fins.

FIG. 1a shows a charging socket 400. It comprises a receptacle 410. A charging cable plug connector 300 with two connecting elements 100 and a housing 200 is arranged in the charging socket 400. The housing 200 can be cross-sectionally adapted to the plug connector receptacle 412. The housing 200 of the charging cable plug connector 300 can rest against the charging socket 400 and, in particular, be connected thereto. For example, these two elements can be connected to one another in a force-fit and/or form-fit manner. For example, screws as shown can hold the charging cable plug connector 300 to the charging socket 400. The second region 120 of the connecting elements 100 protrudes into the receptacle 410. The receptacle 410 can serve to connect a charging plug, with at least one of the plug-in pins 100 serving as a contact pin for the charging plug.

The charging cable plug connector 300 can protrude from the housing of the charging socket, as shown as an example in FIG. 1b. For example, this can be realized by means of a collar 420.

FIG. 2 shows a charging socket 400 of the invention with a charging cable plug connector 300 in a sectional view along the sectional line III in FIG. 1a. Two connecting elements 100, 100′ can be seen. The plug-in pins have a second region 120, a first region 110, a recess 130, as well as a front 122, a rear 112 and a further 114 front face.

A blind hole 132 is arranged in the recess 130. A thickening can be seen on the second region 120 in the transition to the first region 110 of the connecting element 100. This thickening is shown in two stages with a first raised cross-section and a second raised cross-section. In particular, the first increased cross-section is larger than the cross-section of the remaining second region 120 in the plug-in direction, and the second increased cross-section is larger than the first increased cross-section, and thus also higher than the cross-section of the remaining second region 120 in the plug-in direction. A groove 129 is arranged around the second region 120 in the transition between the second region 120 and the first region 110. The groove can accommodate a sealing ring, for example.

The receptacle 410 of the charging socket 400 can also have a rear wall 430. The connecting elements 100, 100′ can be passed through said rear wall. For example, as shown, the sealing ring can be arranged around the second region 120 between the connecting element 100, 100′ and the charging socket 400, in particular the base 430 of the receptacle 410 of the charging socket, in particular in an interference fit.

FIG. 3 shows various embodiments of the connecting elements 100, 100′ according to the invention in single and double versions. In the sectional views shown, the cross section of the first region 110 is shown.

FIG. 3a shows connecting elements 100, 100′ which have a star-shaped, rotationally symmetrical cross section of the first region 110. These are surrounded by a housing 200. The envelopes 160, 160′ are shown with dashed lines. As can be seen, the outline of the cross section of the two connecting elements 100, 100′ is longer than the outline of the envelope 160, 160′. The cross section is therefore at least partially concave. The respective cooling fins 170 are substantially triangular in shape and taper in particular towards their end pointing away from the connecting element 100, 100′.

It can also be seen that the housing 200 is arranged in the gaps between the cooling fins 170—for example, the housing 200 may have penetrated into the gaps.

FIG. 3b shows an alternative cross section in which the cross section of the connecting elements 100, 100′ is not symmetrical. In the case shown, this is due to the different lengths of the cooling fins 170. In the arrangement of two connecting elements 100, 100′, the cooling fins on the side of the connecting element 100, 100′, which face the other connecting element 100, 100′, are shorter than the remaining cooling fins 170. In this way, a directionality of the heat dissipation from the connecting element 100, 100′ into the environment can be ensured. In particular, the heat can be conducted away from the other connecting element 100, 100′.

FIG. 3c shows a further cross-sectional design of the connecting elements 100, 100′. In this case, the cooling fins 170 are arranged only in a subregion of the circumference of the connecting elements 100, 100′. In the present case, the circular arc along which the first region 110 is equipped with cooling fins 170 measures approximately 180°. In the arrangement with two connecting elements 100, 100′, the sides without cooling fins face the other connecting element 100, 100′.

FIG. 3d shows a further embodiment of the cross section of the connecting elements 100, 100′. The cooling fins 170 are tapered at their end pointing away from the relevant connecting element 100, 100′. Cooling fins are also located along the entire circumference of the respective connecting elements 100, 100′. In this case, no side of a connecting element 100, 100′ is free of cooling fins, as is the case, for example, in the embodiment shown in FIG. 3c. The cooling fins 170 vary in their length and are shorter in particular on the side of the relevant connecting element 100, 100′ which faces the other connecting element 100, 100′ than on the side facing away from the other connecting element 100, 100′.

FIG. 3e shows a further profile in which the cooling fins 170 are substantially rectangular in shape and are arranged evenly over the entire circumference of the first region 110 of the connecting element 100.

FIG. 4 shows an isometric view of the connecting element 100 according to the invention. The first region 110 has a plurality of cooling fins 170. The lateral surface 111 is thus characterized by indentations and elevations. The cooling fins extend along the longitudinal direction 150. In the illustrated exemplary embodiment, the cooling fins 170 extend along the entire length of the first region 110 of the connecting element 100. Due to the cooling fins 170, the surface area of the lateral surface 111 is increased in comparison to a lateral surface 111 whose cross section would correspond to the envelope of the cross section as shown in FIG. 4.

In the exemplary embodiment shown, the second region 120 of the connecting element 100 is arranged eccentrically on the first region 110. The second region 120 has a thickening at its end facing the first region 110. The second end face 122 is arranged at the opposite end. A recess 130 is arranged in the first end face 112 of the first region 110. This can also be arranged off center from the central axis of the first region 110.

FIG. 5 shows a charging cable plug connector 300 according to the invention in accordance with an exemplary embodiment. Two connecting elements 100, 100′ are enclosed by a housing 200. The second regions 120 are positioned eccentrically on the first regions 110. The central axes of the second regions 120 are spaced apart by a smaller distance than the central axes of the first regions 110. In the embodiment shown, the cooling fins 170 on the sides of the connecting elements 100, 100′ which face away from the other connecting element 100, 100′ have an increased length compared to the sides which face the other connecting element 100, 100′. This promotes the release of heat to the outside. In particular, an increased temperature is to be expected between the two connecting elements 100, 100′, which is regularly higher than the ambient temperature on the sides facing away from the other connecting element 100, 100′. For this reason, heat transport to the sides of each of the at least two connecting elements 100, 100′ facing away from the other connecting elements is promoted. This can be further enhanced by the choice of the length of the cooling fins.

FIG. 6 shows various representations through connecting elements 100 according to the invention.

Here, FIG. 6a shows an embodiment in which the second region 120 has a smaller diameter, in particular a smaller cross section, than the first region 110. A fastening element 130 is arranged at the first end face of the first region 110. In the exemplary embodiment shown, this is a pin 130, which can, for example, have a thread. The second region 120 is shaped, for example, as a pin.

FIG. 6b shows an embodiment of the connecting element 100 according to the invention in which the second region 120 has substantially the same diameter, in particular the same cross section, as the first region 110. The fastening element 130 in the first end face is a second recess 130 in the embodiment shown. The second region 120 comprises a recess 124. This can, for example, be configured to accommodate a plug, a connecting pin, a rod or the like. For example, the connecting element 100 shown can serve as part of a socket for a charging plug. A plug-in element of the charging plug can, for example, be inserted into the second recess 124 of the connecting element 100. Spring elements 125 can be arranged in the second recess 124 as shown. The spring elements 125 can effect a contact pressure between a plug-in element, which is inserted into the second recess 124, and the connecting element. In this way, the contact resistance between a plug-in element and the connecting element 100 can be reduced.

FIG. 6c shows a further embodiment of the connecting element 100 according to the invention. In this, the cross section and/or the diameter of the second region 120 is larger than that of the first region 110. The second region 120 has a second recess 124. The first region 110 has a fastening element 130 in the form of a recess with an internal thread 130.

For example, an attachment element 500 can be attached to the connecting element 100. In the exemplary embodiment shown, the attachment element 500 is designed as a busbar 500. The busbar 500 comprises a hole, in particular a through-hole 510. The busbar 500 can be connected to the connecting element 100 by means of a screw 520.

FIG. 7 illustrates the characterization of the cooling fins 170 on the connecting elements 100, 100′.

As shown in FIG. 7a, in the case of two connecting elements 100, 100′, one of the two connecting elements 100, 100′, in particular its second region 120, can be separated into two regions by means of a plane A. The plane A is in particular aligned parallel to the central axis B of the relevant connecting element 100, 100′, in particular its first region 110, and runs through it. At the same time, the surface A is oriented perpendicular to the distance vector C between the central axis of the first region 110 of the connecting element 100′ and the central axis of the first region 110 of the connecting element 100.

FIG. 7b shows the cross section of the two connecting elements 100, 100′, in particular their first regions 110. The cross section of the first region 110 of the connecting element 100′ can be divided into two regions 180, 182 by means of the plane A. In the example shown, the cooling fins 170 are arranged exclusively on the side 182 of the connecting element 100′ facing away from the other connecting element 100. On the other hand, no cooling fins are arranged on the side 180 of the connecting element 100′ facing the other connecting element 100.

FIG. 7c shows one possibility of defining the cooling fins 170. For the cross section of a first region 110 of a connecting element 100, an outer envelope 160, already known from the above explanations, can be defined. This was the smallest convex surface which encloses the entire cross section of the first region 110. Similarly, a largest inner convex surface 162 can be defined—which can be arranged within the cross section of the first region 110 of the connecting element 100. All subregions of the cross section of the first region 110 which are not occupied by the largest inner convex surface 162 can be defined as cooling fins 170.

1-41. (canceled)

42. Charging cable plug connector for high voltage applications, comprising:
at least one connecting element, wherein the connecting element has a first region made of a first metal material extending from a first end face to a central region and a second region of second metal material extending from a second end face to the central region, wherein the first metal material is different from the second metal material, and
the first metal material comprises aluminum or an aluminum alloy and the second metal material comprises copper or a copper alloy, or
the second metal material comprises aluminum or an aluminum alloy and the first metal material comprises copper or a copper alloy.

43. Charging cable plug connector according to claim 42, wherein the cross section of the first region of at least one of the connecting elements is at least larger at least in regions than the cross section of the second region of the connecting element.

44. Charging cable plug connector according to claim 42 wherein the first region of at least one of the connecting elements has at least one cooling fin or a plurality of cooling fins, wherein the cooling fins run in particular parallel to the longitudinal axis of the connecting element and preferably
the cooling fins extend in the longitudinal direction of the connecting element substantially along the entire length of the first region, and/or
the cooling fins are arranged circumferentially around the cross section of the first region.

45. Charging cable plug connector according to claim 44 wherein the cooling fins of at least one of the connecting elements differ from one another in their length perpendicular to the longitudinal axis of the connecting element, in particular such that the first region has an asymmetrical, in particular rotationally asymmetrical, axially asymmetrical and/or point-asymmetrical cross section.

46. Charging cable plug connector according to claim 42, wherein the connecting element has on its first end face a first fastening means, in particular a first recess, in particular a first recess tapering towards the central region and/or a first recess with a thread.

47. Charging cable plug connector according to claim 42, wherein the second region of at least one of the connecting elements has a smaller cross section than the first region at least in some regions or entirely.

48. Charging cable plug connector according to claim 42, wherein the central axis of the second region of at least one of the connecting elements is arranged eccentrically to the central axis of the first region of the connecting element.

49. Charging cable plug connector according to claim 46, wherein the first recess is arranged in the first end face of the connecting element eccentrically to the central axis of the first region of the at least one connecting element.

50. Charging cable plug connector according to claim 42, wherein the second region of at least one of the connecting elements is shaped as a pin and/or the second region of the connecting element is at least partially cylindrical in shape or
the second region of at least one of the connecting elements is shaped as a socket, in particular as a sleeve with a base.

51. Charging cable plug connector according to claim 42, wherein the at least one connecting element comprises at least two connecting elements, and
wherein the at least two connecting elements are preferably fixed relative to one another in a housing and
the at least two connecting elements are arranged relative to one another in the plug connector in such a way that their respective longitudinal axes are aligned substantially parallel to one another, in particular so that the at least two connecting elements are fixed in the housing accordingly.

52. Charging cable plug connector according to claim 42, wherein the first region of at least one of the connecting elements and/or both connecting elements has at least one or more cooling fins, wherein the cooling fins on a side of the connecting element facing away from the other connecting element are more numerous, longer and/or have a higher volume than on a side of the connecting element facing the other connecting element.

53. Charging cable plug connector according to claim 51, wherein the housing at least partially encloses the lateral surface of the first region of the first connecting element and the lateral surface of the first region of the second connecting element.

54. Method for producing a connecting element for a charging cable plug connector of claim 42, comprising the steps of
providing a first region made of a first metal material, wherein the first region was previously obtained by means of extrusion and/or was cut to length,
providing a second region made of a second metal material, wherein the second region was previously obtained in particular by means of casting, deep drawing and/or cold extrusion,
materially bonding, in particular welding, an end face of the first region to an end face of the second region.

55. A charging socket having a front side and a rear side facing away from the front side, comprising:
a charging socket receptacle for a charging plug, arranged on the front side,
a charging cable plug connector according to claim 42, arranged at least partially within the receptacle and extending from the front side to the rear side, wherein the first region extends from the rear side in the direction of the charging socket receptacle and the second region extends into the charging socket receptacle.

56. A system comprising:
a charging socket according to claim 55, wherein the charging cable plug connector is connected to the charging socket with a positive and/or non-positive connection, and/or the second region of at least one of the connecting elements of the charging cable plug connector is arranged at least partially in the receptacle of the charging socket, and/or the first end face of at least one of the connecting elements protrudes from the charging socket along the longitudinal direction of the connecting element.
